(19) United States
(12) Patent Application Publication
(10) Pub. No.: US 2022/0162048 A1
(43) Pub. Date: May 26, 2022

(54) Carrier for a Lifting Device, Lifting Device Provided Therewith and Method Therefor

(71) Applicant: Meijer Holding B.V., Sint Jacobiparochie (NL)

(72) Inventors: Hendrik Meijer, Sint Jacobiparochie (NL); Folkert De Graaf, Leeuwarden (NL); Joris Christoffel Van de Wal, Willemsoord (NL)

(21) Appl. No.: 17/436,278

(22) PCT Filed: Mar. 4, 2020
(86) PCT No.: PCT/NL2020/050139

§ 371 Date: Sep. 3, 2021

(30) Foreign Application Priority Data
Mar. 5, 2019 (NL) 2022674

(51) Int. Cl. B66F 17/00; B66F 9/12; B66F 9/24

(52) U.S. Cl. CPC B66F 17/003; B66F 9/24; B66F 9/12

(57) ABSTRACT

The invention relates to a carrier for a load, such as a fork, a fork board and/or lifting device provided therewith and method for displacing goods. The carrier according to the invention comprises: coupling means configured to couple the carrier to the lifting device; a carrier part for carrying loads, wherein the carrier part is provided with a bend sensor extending over a measurement distance and configured to measure a continuous progression of the bending and/or bending angle occurring substantially over the measurement distance.

The invention relates to a carrier, such as a fork for instance for a forklift truck or pallet truck. Such carriers are used for picking up and displacing goods.

Lifting devices are known in practice in the form of inter alia forklift trucks and pallet trucks. These lifting devices are provided with carriers, for instance in the form of forks. Such a fork is for instance described in NL 2018218. The fork described herein is provided with an overloading/excess stress measurement and/or bending measurement and/or length measurement for at least one of the forks of the fork system of the lifting device. Use is for instance made here of an inclinometer and/or strain gauges. It has been found that a bending and/or length of the fork can hereby be measured at a specific location. In the case of length-adjustable forks it is also possible here to additionally make use of a length measurement.

Such known forks have the drawback that a measurement is possible only at a discrete number of points. Alterations to the fork are further usually required here in order to be able to position the sensor in or on the fork. A recess must thus for instance usually be provided in the fork. This increases the cost of such a fork and also impedes application in existing forks. With these conventional measurements insufficient, or insufficiently accurate, information is further obtained about the relevant torque exerted on the fork by the load, and the occurring angle of the forks relative to for instance the ground surface.

The present invention has for its object to provide a carrier, such as a fork, whereby the above stated problems are obviated or at least reduced, such that a bending and/or bending angle of the carrier part of the carrier can be measured in effective manner so that such carriers can inter alia be worked with safely.

This object is achieved with the carrier, such as a fork for a lifting device, according to the invention, wherein the carrier comprises:
coupling means configured to couple the carrier to the lifting device;
a carrier part for carrying loads,
wherein the carrier part is provided with a bend sensor extending over a measurement distance and configured to measure a continuous progression of the bending and/or bending angle occurring substantially over the measurement distance.

The carrier according to the invention can be provided as a separate component and be mounted releasably on for instance a fork board of a lifting device, as well as for instance be welded fixedly to a fork adjuster. This lifting device relates particularly to a forklift truck, however can also relate to a pallet truck, AGV, and other types of forklift truck, such as a mast forklift truck or truck-mounted forklift truck, and carriers for (automated) warehouses. These forks are usually applied as a set of two forks. The carrier can also relate to other load carriers, such as a coil boom for for instance steel rolls and carpet rolls, and crane arms. In a possible embodiment it is also possible to apply the carrier in the form of a so-called extending fork.

According to the invention, the fork is provided with coupling means, preferably releasable coupling means, with which the fork can be coupled to the lifting device. The fork is further provided with a carrier part on which loads and/or goods can be placed. By providing this carrier part according to the invention with a bend sensor, wherein this sensor extends over a certain measurement distance with a measurement length, the bending and/or bending angle of the carrier part can be determined over a substantially continuous measurement distance. A substantially continuous progression of the bending and/or bending angle can hereby be determined. The measurement distance can extend over a vertical and/or horizontal part of the carrier part of the carrier.

Determining a substantially continuous progression of the bending and/or bending angle over the measurement distance of the carrier part achieves that for instance the location of the load and the corresponding torque can be determined in relatively accurate manner This provides a relatively accurate impression of a possible overloading of the forks.

A particular advantage of the fork according to the invention is that it can be used in combination with a dynamic monitoring of overloading of or excess stress on the fork(s). A fork can for instance carry along less cargo on the front side (free outer end) of the fork as a result of the torque action. Because the location of the load can be accurately determined and the bending and/or bending angle can be determined over a substantial part of the fork, with a substantially continuous progression over the measurement distance, a greater reliability of the load is obtained. This considerably increases the safety of working with the fork. If desired, it is possible to also perform a weight determination.

It is further possible to use the measurement data as information for a tilting system of for instance a forklift truck. In the case of (extensive) bending the tilting system of a forklift truck can be activated in order to maintain or obtain a safe situation. It is hereby possible to anticipate the bending, and unsafe situations will be avoided as far as possible.

A further advantage of a currently preferred embodiment according to the invention is that the degree of spring-back can be determined, also after the load is removed. It is hereby possible to determine whether a plastic deformation of the fork has occurred. By following such a deformation in time it is possible to determine whether slow plastic deformation of the fork is occurring, and maintenance or replacement may be necessary. It is also possible to detect wear, for instance at the heel of the fork, and thereby enable preventive maintenance. This has the additional advantage that no separate checks of this component are necessary, since this possible wear can be measured during operation. This increases the utility of the lifting device according to the invention.

The measurement distance preferably extends over a length of at least 10% of the length of the carrier part of the carrier, preferably at least 25%, more preferably at least 40%, still more preferably at least 50%, still more preferably at least 75%, and most preferably amounts to at least about 90% of this length. A substantial measurement length is hereby obtained over a large part of the carrier part of the fork. It has been found that it is hereby possible to determine for instance the above stated plastic deformation, for instance to the order of magnitude 0.1 mm.

In a preferred embodiment according to the invention the carrier part is provided over a measurement distance with a groove or recess in which the bend sensor can be at least partially received.

By providing a groove or recess the bend sensor can be protected over the measurement distance against wear or against impact with other objects. The lifespan of such a sensor is hereby increased, and the accuracy is preserved. The bend sensor is here preferably arranged in a groove or recess on the side of the fork. In a currently preferred embodiment possible electronics can be arranged in or close to the nose of the fork. A compact integration of the measurement components in the fork according to the invention is hereby possible.

In an advantageous embodiment according to the invention the measurement distance extends over both a substantially horizontal part and a substantially vertical part of the carrier part of the carrier.

Having the measurement distance extend over a substantially horizontal and a vertical part of the carrier part of the carrier achieves that the most complete signaling possible of the load and possible deformation of the carrier is obtained. The most complete view possible of the effects of the load on the carrier is hereby obtained.

In an advantageous embodiment according to the invention the sensor comprises a glass fibre cable.

By providing a glass fibre cable, also referred to as optical fibre cable, a wave-guide is obtained whereby a signal can be transmitted through the cable. Due to a deformation of the cable as a result of for instance bending of the fork, it is possible to calculate in effective manner where the bending is taking place and what the extent of it is. This is for instance possible in that a bend changes the frequency of the signal, whereby such a determination can be carried out accurately in effective manner This is for instance also possible by observing loss of signal (strength). The optical fibre cable is here preferably arranged in the above described groove or recess, more preferably on the side of the fork.

As alternative to or in addition to the optical fibre cable the sensor can further comprise a resistance sensor, such as a strain gauge sensor, wire sensor, resistance layer for measuring change in resistance. Such a sensor thereby makes use of a resistance measurement whereby a bending can if desired also be determined. If desired, the sensor can make use of additional sensors, such as an inclinometer, draw wire sensor, laser, ultrasonic sensor, flow sensor, whereby the accuracy of the measurement can be further increased and the measurement can optionally be combined with a length measurement of the fork. This further increases the available amount of measurement information, particularly in the case of extendable forks, in order to thereby avoid or at least reduce risks of damage.

In an advantageous embodiment according to the invention the fork comprises a transmitter configured to transmit one or more measurements to a bending controller.

By making use of a transmitter a measurement can be transmitted wirelessly to a bending controller. Such a bending controller is preferably provided on the lifting device, particularly the forklift truck, and/or in a control room and/or on a driver in the form of a mobile phone or tablet or smart watch and the like. It is also possible to consider the bending controller a part of the fork according to the invention, and optionally mount it thereon or therein wholly or partially. The information obtained with the transmitter (and sensor/sensors) can be used by the bending controller for storing data for the purpose of training users of a lifting device, recording information for insurance purposes in the case of damage, and for determining for instance pallet weights during handling thereof.

The transmitter is preferably provided with an energy source. Such an energy source is for instance used for transmitting a wireless signal and can for instance be charged in wireless manner, for instance by making use of a so-called piezo-element which, if desired, can generate energy in combination with the load, and/or by making use of an inductive charging process. Alternatively or additionally, the energy source can for instance also be charged using a cable and/or be coupled to the battery of the lifting device, wherein this battery can if desired function as energy source.

In an advantageous embodiment according to the invention the fork is provided with an alarm for indicating excess stress ascertained with the bend sensor.

By providing an alarm, an alarm signal can be generated for a user or another person in the case that an excessive bending of and/or excess stress on the fork is ascertained. This user or other person can then undertake action. The lifting device itself can also take measures. It is thus for instance possible for an AGV provided with a fork according to the invention to for instance comes to a standstill as a result of such an alarm. It will be apparent that various embodiments of an alarm are possible.

The invention further relates to a fork board for a lifting device and/or such a lifting device, such as a forklift truck, comprising a fork in an embodiment according to the invention.

Such a fork board and/or such a lifting device provide similar advantages and effects as described for the fork. This lifting device relates in particular to a forklift truck, but can also relate to a pallet truck, AGV, as well as other types of forklift truck such as a mast forklift truck or truck-mounted forklift truck, and carriers for (automated) warehouses.

In a possible embodiment of the lifting device it is provided with a bending controller configured to receive a measurement from the bend sensor. It is hereby for instance possible to provide an alarm. This increases the general safety of working with the lifting device further.

In a further embodiment according to the invention the lifting device is for instance further provided with a tilting system for correcting the position of the forks for a measured bending. By providing a tilting system an undesired degree of bending can if desired be compensated by tilting the forks, as already elucidated above. Such a tilting system can be present in usual manner on the lifting device, particularly on the forklift truck, and can for instance be provided on the so-called fork back. Such a tilting system on the fork back is preferably embodied as separate module in order to thereby have the ability to be applied in universal manner for different types of fork and/or different types of lifting device. Use is for instance made here of a preferably compact hydraulic or electric cylinder with a limited incorporating structure which is integrated on or in the fork back, particularly in suspension claws or fork back. In a currently preferred embodiment the tilting system is operatively connected to the controller which is preferably arranged in a cab of a forklift truck. A driver can hereby control the tilting system in effective manner According to the invention, it is also possible that the controller controls the tilting system in automatic manner on the basis of the performed measurements.

The invention further also relates to a method for measuring a bending and/or bending angle of a fork, comprising the steps of:
providing a fork in an embodiment according to the invention; and
performing a measurement.

Such a method provides similar advantages and effects for the fork and/or lifting device. It is hereby particularly possible to provide safe use of the forks according to the invention. Additional information can also be obtained.

In advantageous embodiments it is possible here to envisage detecting an occurring plastic deformation with a bending controller. Such a detection can be performed during use. Maintenance can hereby be planned in timely manner Excess stress can also be detected with such a bending controller, so that action can be taken if desired, for instance by generating an alarm notification. By detecting preventive maintenance moments and/or determining maintenance intervals, the efficiency and effectiveness of the device and method according to the invention are hereby increased.

It is further possible to have the fork and/or lifting device communicate using the transmitter with an external system, for instance a planning system, stock control system, maintenance system and/or other ERP system. In such an embodiment of the invention the lifting device is hereby further integrated with relevant operational processes. It is thus for instance possible to link the use of a lifting device according to the invention to the cargo, and thereby for instance specifically allocate the cost of the use of the forklift truck. This increases the safety of and control over the logistical processing in for instance a distribution centre or other warehouse. As part of an ERP system, or in addition thereto, measured data can also be stored in a data logger or other data storage system. This makes data available for determining for instance maintenance intervals, degree of use of so-called attachments, and other logistical information.

Further advantages, features and details of the invention are elucidated on the basis of preferred embodiments thereof, wherein reference is made to the accompanying drawings, in which:

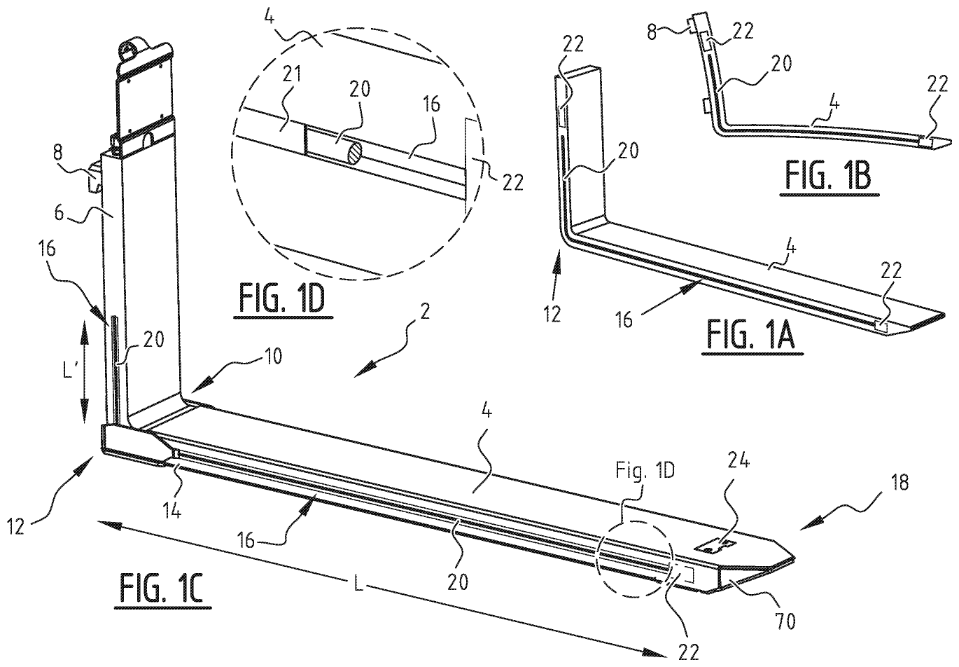

FIGS. 1A-D show views of the fork with bend sensor according to the invention;

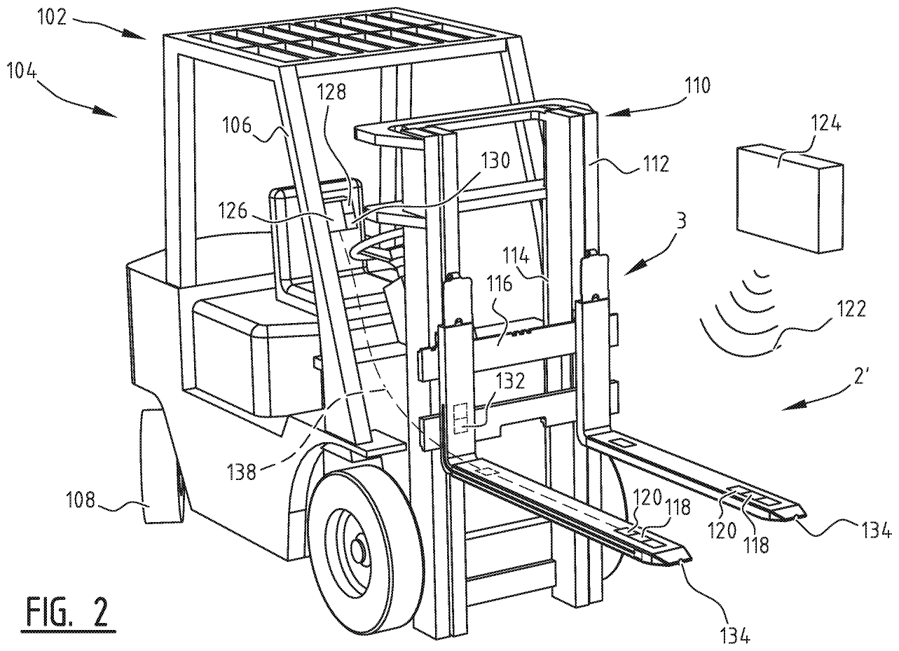

FIG. 2 shows a forklift truck provided with the fork of FIG. 1;

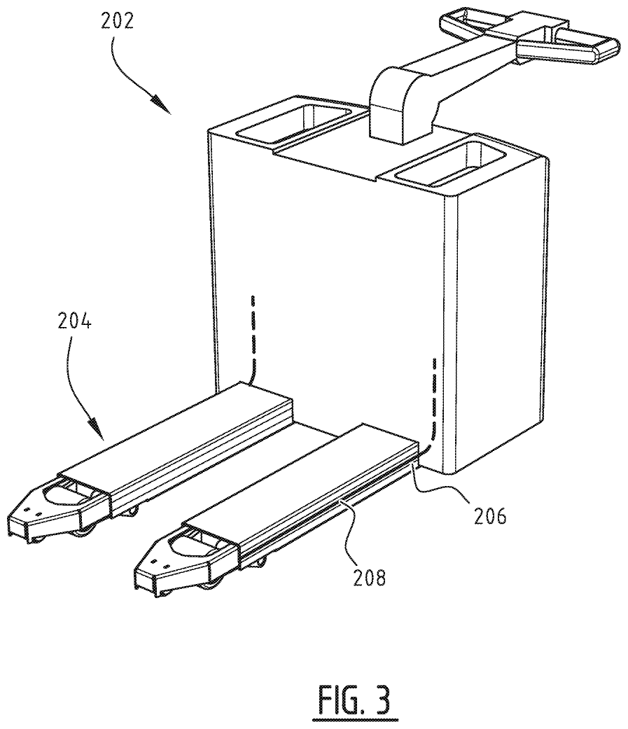

FIG. 3 shows a pallet truck provided with the fork of FIG. 1; and

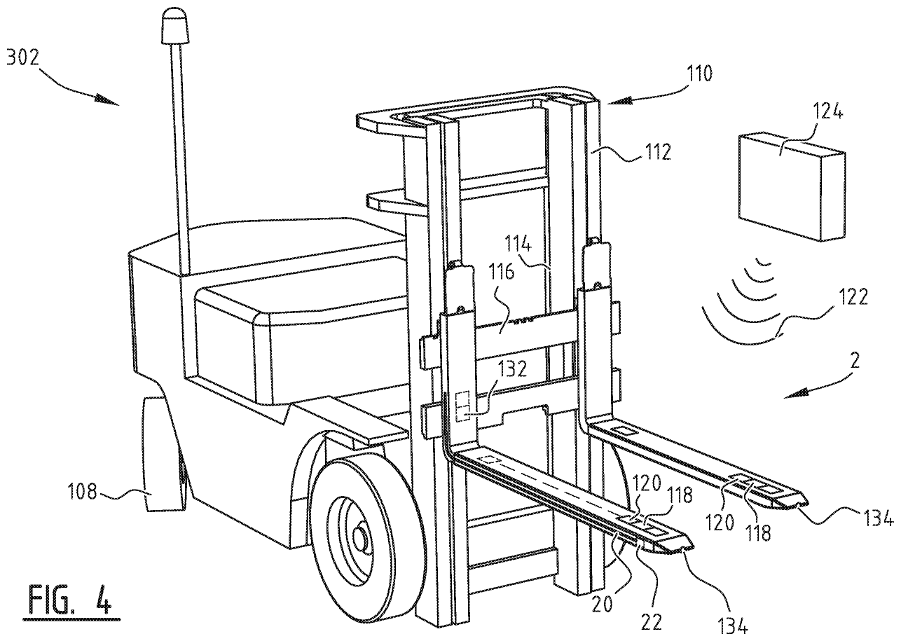

FIG. 4 shows an AGV provided with the fork of FIG. 1.

Carrier 2, represented in the shown embodiment as fork 2 (FIGS. 1A-D), is provided with a carrier part 4 which extends substantially in horizontal direction during use and a vertical part 6 which extends substantially in vertical direction during use and on which coupling elements 8, for instance in the form of a hook, are provided. Parts 4, 6 are connected at transition 10, where the so-called heel 12 of fork 2 is provided, optionally provided with wear-limiting elements. In the shown embodiment side 14 of carrier part 4 is provided with groove 16 which extends over substantially the whole (substantially) horizontal length L of carrier part 4 and a part of the (substantially) vertical length L′. In this embodiment the measurement distance of carrier part 4, 6 goes as it were ‘round the bend’. The horizontal length L of carrier part 4 extends between transition 10 and nose 18 at the outer end of fork 2. In the shown embodiment fork 2 is arranged on fork board 3. Fork 2 can relate to a fixed fork 2 (FIG. 1A) and to an extending fork 2 (FIG. 1C). The components and effects described in the context of the present invention apply to both forks 2 and to other types of carrier, including coil booms, crane arms and the like.

Arranged in groove 16 of carrier part 4, 6 is optical fibre cable 20 which is operatively connected to measurement electronics 22, which in the shown embodiment are arranged in or close to nose 18 of fork 2 (FIGS. 1A and C) and in vertical carrier part 6 (FIG. 1A). Additional sensor element 24 is optionally arranged on or in carrier part 4. It will be apparent that the location of an additional sensor element 24 and/or measurement electronics 22 can be adapted to the sensor in question. Possibly occurring bending (FIG. 1B) of fork 2 is shown schematically. In the shown embodiment optional cover strip or cover plate 21 (FIG. 1D) is provided for the purpose of shielding cable 20.

Forklift truck 102 (FIG. 2) is provided with cab 104, frame 106 and a number of wheels 108. Provided on front side 110 of forklift truck 102 is mast construction 112. In the shown embodiment construction 112 is provided with two guides 114 in which or on which fork board 116 is arranged. Fork 2 according to the invention is arranged on fork board or connecting element 116. Provided in a possible embodiment is an optionally slidably adjustable fork part (not shown) which functions as outer fork.

Further provided in the shown embodiment is transmitter-receiver or transmitter 118, as well as energy source or power supply system 120, for instance embodied as an accumulator or battery. Transmitter-receiver 118 communicates via signals 122 with external control system 124, for instance an ERP system. In the shown embodiment control box or interface 126, which is provided in the shown embodiment with bending controller 128 and alarm 130, is alternatively or additionally arranged in cab 104. Also provided in the shown embodiment is additional sensor block 132 for an additional sensor and/or reference point which is operatively connected to other components. In the shown embodiment forklift truck 2 is further provided with laser pointer 134 in or close to nose 18. If desired, a cabled information transfer can additionally or alternatively be provided, for instance by making use of channel/cable 138 between sensor and control box 126.

Pallet truck 202 (FIG. 3) can likewise be provided with a fork 204 of the type shown in FIG. 1. There is here also a groove 206 in which optical fibre cable 208 is arranged. Fork 2 can also be applied in a so-called AGV 302 (FIG. 4). It will be apparent that components of the various embodiments are interchangeable and/or applicable in other possible embodiments according to the invention.

When placing goods on fork 2, particularly carrier part 4 thereof, bending of carrier part 4 in particular will occur in the case of a significant load. Due to a change in the signal through optical fibre cable 20, a signal will be determined with the measurement electronics 22, with which signal it has been found possible to determine an exact location of the occurring deformation. Such a measurement can be passed on to an external system 124 and/or control 126 on lifting device 102, 202, 302. If desired, settings of lifting system 102, 202, 302 are adjusted on the basis of the obtained information. It is for instance possible here to envisage the tilt angle. In the case of an extendable fork it is also possible to adjust the length setting. System 124 makes it possible to plan maintenance or perform the necessary monitoring, for instance in respect of wear.

The present invention is by no means limited to the above described preferred embodiments thereof. The rights sought are defined by the following claims, within the scope of which many modifications can be envisaged.

1. A carrier for loads, such as a fork for a lifting device, comprising:
coupling means configured to couple the carrier to the lifting device;
a carrier part for carrying loads,
wherein the carrier part is provided with a bend sensor extending over a measurement distance and configured to measure a continuous progression of the bending and/or bending angle occurring substantially over the measurement distance, and wherein the measurement distance extends over a vertical and/or horizontal part of the carrier part of the carrier.

2. The carrier according to claim 1, wherein the measurement distance extends over at least 10% of the length of the carrier part of the carrier, preferably at least 25%, more preferably at least 40%, still more preferably at least 50%, still more preferably at least 75%, and most preferably at least 90% of the length of the carrier part of the carrier.

3. The carrier according to claim 1, wherein the carrier part is provided over the measurement distance with a groove or recess in which the bend sensor can be at least partially received.

4. The carrier according to claim 1, wherein the measurement distance extends over both a substantially horizontal part and a substantially vertical part of the carrier part of the carrier.

5. The carrier according to claim 1, wherein the sensor comprises an optical fiber cable.

6. The carrier according to claim 1, wherein the sensor further comprises a strain gauge sensor or resistance sensor.

7. The carrier according to claim 1, further comprising a transmitter configured to transmit one or more measurements to a bending controller.

8. The carrier according to claim 7, further comprising an energy source.

9. The carrier according to claim 7, further comprising an alarm for indicating excess stress.

10. (canceled)

11. A lifting device, such as a forklift truck, comprising a carrier and/or fork board according to claim 1.

12. The lifting device according to claim 11, further comprising a bending controller configured to receive a measurement from the bend sensor.

13. A method for measuring a bending and/or bending angle of a carrier, comprising the steps of:
providing a carrier according to claim 1; and
performing a measurement.

14. The method according to claim 13, further comprising of detecting a plastic deformation with a bending controller.

15. The method Method according to claim 13, further comprising of detecting excess stress with a bending controller.

16. The method according to claim 15, further comprising the step of generating an alarm notification.

17. The method according to claim 13, further comprising of detecting a preventive maintenance moment or maintenance interval.

18. The carrier according to claim 2, wherein the measurement distance extends over both a substantially horizontal part and a substantially vertical part of the carrier part of the carrier.

19. The carrier according to claim 3, wherein the measurement distance extends over both a substantially horizontal part and a substantially vertical part of the carrier part of the carrier.

20. The carrier according to claim 4, wherein the sensor comprises an optical fiber cable.

21. The carrier according to claim 4, further comprising a transmitter configured to transmit one or more measurements to a bending controller and further comprising an energy source.
